(19) United States
(12) Patent Application Publication
(10) Pub. No.: US 2004/0198311 A1
(43) Pub. Date: Oct. 7, 2004

(54) Method and system for processing a service access request for a mobile communication device

(76) Inventors: Naveen Aerrabotu, Gurnee, IL (US); Charles Philipp Binzel, Bristol, WI (US); Bharat Srinivasan, Arlington Heights, IL (US)

Correspondence Address: MOTOROLA INC, 600 NORTH US HIGHWAY 45, ROOM AS437, LIBERTYVILLE, IL, 60048-5343, US

(21) Appl. No.: 10/295,979

(22) Filed: Nov. 15, 2002

(51) Int. Cl. H04M 11/00; H04M 1/66; H04M 1/68; H04M 3/16; H04Q 7/20

(52) U.S. Cl. 455/404.1; 455/466; 455/411

(57) ABSTRACT

A system and method of establishing a network connection for a mobile communication device in a mobile communication network. The method can include receiving an emergency service call identifier from an unregistered mobile communication device, the emergency service call identifier identifying an emergency service request to a home service center, and routing the emergency service request to the home service center. The emergency service call identifier can include a subscriber identification. The method can also include sending a short message service message to the mobile communication device. The short message service message can include an unblock code.

### CROSS-REFERENCE TO RELATED APPLICATIONS

This application is related to the application entitled “Method and Apparatus for Operating a Blocked Secure Storage Memory,” Motorola case number CS21457RL, and the application entitled “Method and Apparatus for Service Access for a Mobile Communication Device,” Motorola case number CS90074, both filed on even date herewith and commonly assigned to the assignee of the present application.

### BACKGROUND OF THE INVENTION

1. Field of Invention

The present invention is directed to a method and system for processing a service access request for a mobile communication device. In particular, the present invention is directed to a method and system for establishing a service access communication for an unregistered mobile communication device.

2. Description of Related Art

Presently, secure storage memories such as identity modules are used in mobile communication devices. Such identity modules can include subscriber identity modules, removable user identity modules, or any other devices useful for storing information in a mobile communication device. An identity module can include information related to a user of the mobile communication device. Specifications for an example identity module are described in “Digital cellular telecommunications system (Phase 2+); Specification of the Subscriber Identity Module—Mobile Equipment (SIM-ME) interface (GSM 11.11 version 8.2.0 Release 1999),” which is hereby incorporated by reference.

In operation, an identity module may block access to information or functions of the identity module for security purposes. For example, the identity module may require an access code, such as a personal identification number or card holder verification information, to grant access rights to data and functions of the identity module. If the access code is incorrectly entered three consecutive times, the identity module can enter a blocked mode. For example, the identity module may enter a blocked status of an access code. Thus, if the access code function is enabled and the status is blocked, a mobile communication device will determine such and end an access attempt. Therefore, in a blocked mode, the access attempt is finished unsuccessfully.

For security purposes, if the identity module is in a blocked mode, no data can be retrieved from the identity module and a mobile communication device using the identity module cannot be registered on a mobile communication system. Thus, when the identity module is in a blocked mode, the only communication allowed for the mobile communication device is for an emergency call, such as a 911 emergency call.

When the identity module is in a blocked mode, the only way to use the mobile communication device for other communications is to unblock the identity module. To unblock the identity module, a specific unblock code must be entered into the identity module. Such an unblock code can include an unblock card holder verification value, a personal identification number unblocking key, or other like code. This unblock code is obtained from a home service center. For example, a subscriber desiring to use a blocked mobile communication device must contact the home service center on which the identity module is subscribed. The home service center then obtains validation information from the subscriber to verify the subscriber is the proper owner of the identity module. Upon verification, the home service center can provide an unblock code to unblock the identity module.

Unfortunately, a subscriber may not be able to contact the home service center. In particular, because the mobile communication device cannot register on a network due to the identity module being blocked, the subscriber cannot use the mobile communication device to contact the home service center. This is especially problematic when the subscriber is in an area where the local mobile communication network is not the subscriber's home mobile communication network. For example, the subscriber may be in a foreign country where the subscriber cannot conveniently contact the subscriber's home service center. This creates the unfortunate situation where it is nearly impossible for the subscriber to obtain an unblock code. Thus, the subscriber is prevented from using the mobile communication device for an extended period of time.

Thus, there is a need for method and apparatus for establishing a service access communication for a device having a blocked secure storage memory such as a blocked identity module.

### SUMMARY OF THE INVENTION

The present invention provides a system and method of establishing a network connection for a mobile communication device in a mobile communication network. The method can include receiving an emergency service call identifier from an unregistered mobile communication device, the emergency service call identifier identifying an emergency service request to a home service center, and routing the emergency service request to the home service center. The emergency service call identifier can include a subscriber identification. The method can also include sending a short message service message to the mobile communication device. The short message service message can include an unblock code. The receiving step can include receiving the emergency service call identifier during a call type setup. The receiving step can further include receiving the emergency service call identifier during a random access request from the mobile communication device on a random access channel. The emergency service call identifier can include a subscriber identification and a random access channel emergency service call type. The mobile communication network can be local to the mobile communication device and the mobile communication network can be remote from the home mobile communication network of the mobile communication device. The receiving step can also include receiving an emergency service call identifier from the unregistered mobile communication device having a blocked subscriber identity module. The method can additionally include receiving, from the home service center, an unblock code including data for unblocking the subscriber identity module, and forwarding the unblock code to the unregistered mobile communication device.

According to another embodiment, the present invention provides a system for communication using a mobile communication device. The system can include a local network and a controller coupled to the local network. The controller can be configured to receive an emergency service call identifier from an unregistered mobile communication device on the local network, the mobile communication device being in a blocked mode, the emergency service call identifier identifying an emergency service request to a home service center, and the controller is further configured to route the emergency service request to the home service center. The controller can be further configured to receive a subscriber identity from the mobile communication device, forward the subscriber identity to the home service center, receive an unblock code from the home service center, and send the unblock code to the mobile communication device. The controller can be further configured to send a short message service message including an unblock code to the unregistered mobile communication device. The controller can also be configured to receive the emergency service call identifier during a call type setup. The controller can additionally be configured to receive the emergency service call identifier during a random access request from the mobile communication device on a random access channel. The mobile communication network can be local to the mobile communication device and the mobile communication network can be remote from the home mobile communication network of the mobile communication device. The controller can be further configured to receive an emergency service call identifier from the unregistered mobile communication device having a blocked subscriber identity module. The controller can also be configured to receive, from the home service center, an unblock code including data for unblocking the subscriber identity module and forward the unblock code to the unregistered mobile communication device.

According to another embodiment, the present invention provides a method of establishing a network connection for a blocked mobile communication device in a mobile communication network. The method can include receiving a service request from the blocked mobile communication device in an random access communication on a random access channel, receiving international mobile subscriber identification information from the blocked mobile communication device, and forwarding the international mobile subscriber identification information to a home service center. The method can also include receiving unblocking information from the home service provider and forwarding the unblocking information to the blocked mobile communication device.

### BRIEF DESCRIPTION OF THE DRAWINGS

The preferred embodiments of the present invention will be described with reference to the following figures, wherein like numerals designate like elements, and wherein:

FIG. 1 is an exemplary illustration of a mobile communication device according to a first embodiment;

FIG. 2 is an exemplary block diagram of the mobile communication device according to another embodiment;

FIG. 3 is an exemplary block diagram of an identity module according to a preferred embodiment;

FIG. 4 is an exemplary flowchart outlining the operation of the identity module according to a preferred embodiment;

FIG. 5 is an exemplary block diagram of a system for mobile communication according to one embodiment; and

FIG. 6 is an exemplary flowchart outlining the operation of the local network controller according to a preferred embodiment.

### DETAILED DESCRIPTION OF PREFERRED EMBODIMENTS

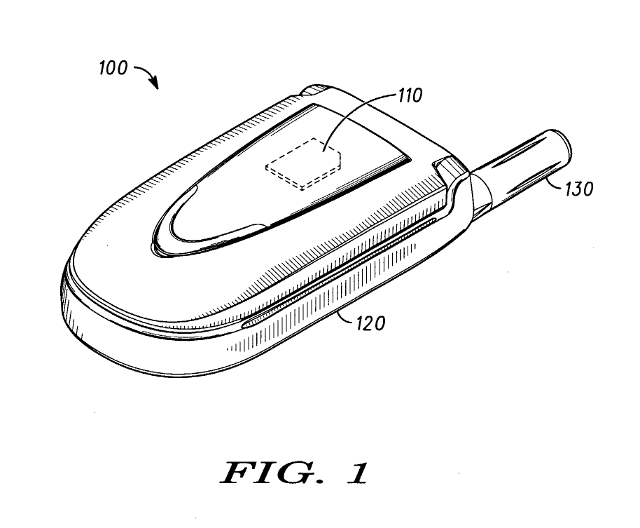

FIG. 1 is an exemplary illustration of a mobile communication device 100 according to a preferred embodiment. The mobile communication device 100 may be a wireless telephone, a cellular telephone, a personal digital assistant, a portable computer, a pager, or any other device that is capable of sending and receiving data. Preferably, the mobile communication device 100 is a portable telephone. The mobile communication device can include a mobile communication device frame 120, an identity module 110 coupled to the frame, and an antenna 130. The mobile communication device frame may include a flip housing, a candy bar housing, or any other housing or frame for a mobile communication device.

The identity module 110 may be a subscriber identity module, removable user identity module, a card including user information such as subscriber information, or any other device useful for storing information in a mobile communication device. The identity module 110 can include a secure intelligent file system that stores information relevant to a user of the mobile communication device 100. This information can include user information such as identification information, validity codes for authentication purposes, phonebooks, datebooks, preferred networks, system identifications, network identifications, and any other useful user information. The information can further include a subscriber identity such as an international mobile subscriber identity or other subscriber identity information. The subscriber identity can include information regarding a user's home network and information regarding user identification. This subscriber identity information can uniquely identify the user and can uniquely identify the user's home network. For example, the subscriber identity can include home public land mobile network information indicating the user's home network.

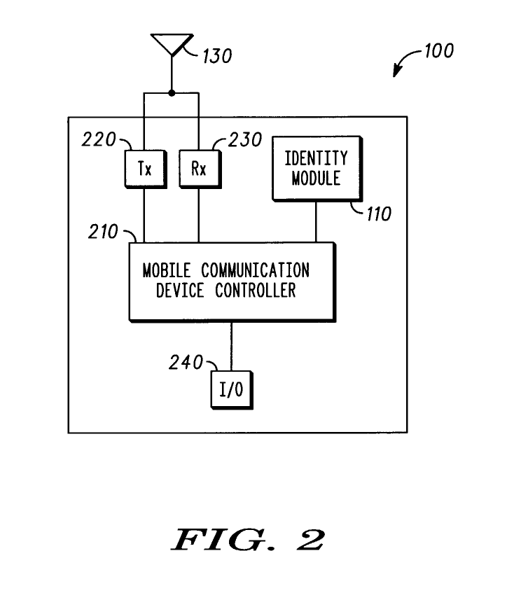

FIG. 2 is an exemplary block diagram of the mobile communication device 100 according to another embodiment. The mobile communication device 100 can include a mobile communication device controller 210, a transmitter 220, a receiver 230, and input and output components 240. The input and output components 240 can include a display, a keyboard, a microphone, a speaker, or any other components useful for inputting and outputting information in a mobile communication device.

In operation, the mobile communication device controller 210 controls the operation of the components of the mobile communication device 100. The transmitter 220 transmits signals from the mobile communication device 100 and the receiver 230 receives signals sent to the mobile communication device 100. The input and output components 240 provide for the input and output of data and communications in the mobile communication device 100.

According to a preferred embodiment the mobile communication device controller 210 can operate by entering a blocked mode of the mobile communication device 100 and/or the subscriber identity module 110. For example the blocked mode may be entered after a predetermined number of failed attempts at entering an access code. When the subscriber identity module 110 is blocked, the subscriber identity module 110 can block access to user information and allow access to subscriber identification information for an emergency service communication. For example, when a subscriber needs to call a home service center to obtain an unblock code. The mobile communication device controller 210 can then access the subscriber identification information on a blocked subscriber identity module 110. The mobile communication device controller 210 can then transmit an initial access including a random access burst on a random access channel. The mobile communication device controller 210 can then send an emergency service access call identifier identifying an emergency service communication request to a home service center. The mobile communication device 100 does not need to be registered on the mobile communication network to engage in an emergency service communication. The mobile communication device controller 210 can then transmit an initial access on an access channel. The initial access can be an access probe, a random access burst, or the like. The emergency service call identifier can be sent in the random access burst on the random access channel. The random access burst can include an emergency service communication request type on the random access channel. The emergency service call identifier can also be sent when sending call setup information. For example, the emergency service call identifier can be sent when sending identification information and call type information to a network. For example the identity of the mobile communication device does not have to be verified and the mobile communication device does not have to be designated as valid for service to place an emergency service communication. The mobile communication device controller 210 can then transmit the mobile communication subscriber identification information. The mobile communication subscriber identification information can include a subscriber identity. The mobile communication device controller 210 can then display call information including an unblock code on the mobile communication device while the in the blocked mode. The mobile communication device controller 210 can alternately audibly output the unblock code. Furthermore, the mobile communication device controller 210 can automatically enter the unblock code to unblock the identity module 110.

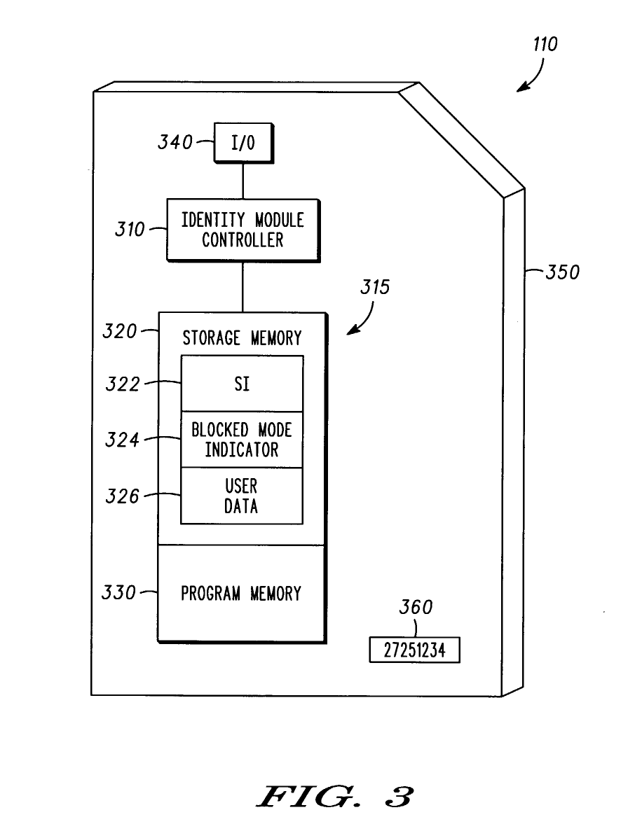

FIG. 3 is an exemplary block diagram of an identity module 110 according to a preferred embodiment. The identity module 110 can include an identity module controller 310, a memory 315 including a storage memory 320 and a program memory 330, input and output circuitry 340, and a frame 350. The identity module 110 can also include an individual account identifier 360 displayed on the frame 350. The individual account identifier 360 can display a subscriber identity. The storage memory 320 can include a subscriber identity 322, a blocked mode indicator 324, and user data 326. The blocked mode indicator 324 may be a register or any other useful information for indicating a blocked mode of the identity module 110 or the mobile communication device 100. The memory 315 may comprise a random access memory, a read only memory, programmable logic circuitry, or any other circuitry or elements useful for storing data.

In operation, the identity module controller 310 can control the operations of the identity module 110. For example, the identity module controller 310 can control access to data located in the memory 310. The input and output circuitry 340 can communicate with the circuitry of the mobile communication device 100. For example the mobile communication device controller 210 can communicate with the identity module controller 310 via the input and output circuitry 340. The memory 315 can store data and commands of the identity module 110. As indicated above, the storage memory 320 can store a subscriber identity 322, a blocked mode indicator 324, and user data 326. The user data 326 can include identification information, validity codes for authentication purposes, phonebooks, datebooks, preferred networks, system identifications, network identifications, and any other useful user information. The program memory can store commands used by the identity module controller 310 to control the operations of the identity module 110.

According to one embodiment, the memory 315 is a secure storage memory. In particular, the memory 315 is secure because the identity module controller 310 controls access to the memory 315. For example, the identity module controller 310 can require a password to enable the identity module 110 and allow access to the memory 315. The memory 315 can include the subscriber identity 322 such as a mobile communication device subscriber identity and the user data 326 such as user information. The identity module controller 310 can be coupled to the secure storage memory 315 and the frame 350. The identity module controller can block access to the user information 326 but grant access to the mobile communication device subscriber identity 322 when the identity module 110 enters a blocked mode. When in the blocked mode, the identity module controller 310 or the mobile communication device controller 210 may grant the access to the mobile communication device subscriber identity 322 only in response to a request for a service access communication or another designated request.

For example, the identity module 110 can become blocked when a specific number of failed attempts are made to enter a password. Thus, the identity module controller 310 can block access to the memory 315. However, the identity module controller 310 or the mobile communication device controller 210 may allow access to the mobile communication device subscriber identity 322 if the user attempts a service access communication. The blocked mode indicator 324 can have a blocked mode status and an unblocked mode status. Thus, the blocked mode indicator 324 can indicate when the identity module 110 is blocked or unblocked. The identity module controller 320 can thus be configured to grant access to the mobile communication device subscriber identity 322 when the blocked mode indicator 324 is in a blocked mode status and thus indicates the identity module 110 is in a blocked mode. Alternatively, if necessary, a user can manually enter the subscriber identity via the input and output components 240, for example, when the identity module 110 is not present or does not support access to the subscriber identity while blocked. Also, the identity module controller 310 can switch the identity module 110 to an unblocked mode upon receipt of an unblock code from the user. For example, the user can enter an unblock code through the input and output components 240. The mobile communication device subscriber identity 322 can be an international mobile subscriber identity. The program memory 330 can include an identity module code. The identity module controller 310 can execute the identity module code for operation of the identity module 110.

For example, when the identity module 110 enters a blocked mode, the user can be informed of the blocked mode via a display in the input and output components 240. The user can also be informed of a specific key sequence that can be entered to make an emergency service access communication. This service access communication is different from an emergency call, such as a 911 call, in that the communication can put the user in contact with the user's home service center such as a service provider. The home service center may then request personal information from the user to validate the user. Such information may include the user's social security number, the user's mother's maiden name, or any other personal information. Upon validation, the home service center can then provide an unblock code to the user to allow the user to unblock the identity module 110.

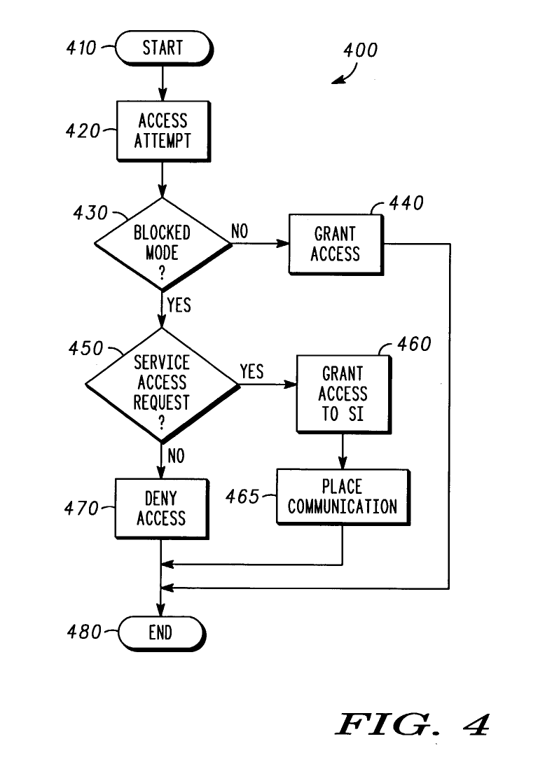

FIG. 4 is an exemplary flowchart 400 outlining the operation of the identity module 110 according to a preferred embodiment. Steps of the flowchart 400 may be performed either in the mobile communication device controller 210 or in the identity module controller 310. In step 410, the flowchart begins. In step 420 an access attempt is made to data in the memory 315 of the identity module 110. In step 430, a determination is made if the identity module 110 is in a blocked mode. For example the blocked mode indicator 324 may be checked to determine if the identity module 110 is in a blocked mode. If the identity module 110 is not in a blocked mode, access is granted to the data. If the identity module 110 is in a blocked mode, a determination is made if a service access request is being made in step 450. If a service access request is being made, access is granted to the subscriber identity in step 460 and a communication is allowed to the user's service provider in step 465. If a service access request is not being made, access is denied in step 470. In step 480, the flowchart ends.

According to another embodiment, a blocked mode may be entered for the identity module 110 if a predetermined amount of failed attempts are made at entering a password or access code since the last correct access code. This access code may be a personal identification number, card holder verification information, or the like. The blocked mode may block access to access code entry and thus, access to information in the identity module 110. When an access request is received, a determination is made of whether the identity module 110 is in a blocked mode. If the identity module 110 is in a blocked mode, the access is denied if the access request is for user data 326. If the access request is a service access request as indicated by a specific key sequence on the keypad of the input and output components 240, access is granted to the subscriber identity 322. This subscriber identity 322 may be an international mobile subscriber identity. A service access communication is then placed to the user's home service provider. The service access communication may be identified as such by indicating the communication type in a transmission on a random access channel, during call setup, or otherwise. The user's home service provider can then provide an unblocking code such as a value to unblock the access code, a personal identification number unblocking key, or any other code. This unblocking code may be provided audibly to the user, visually to the user, or directly to the identity module 110. For example, a short messaging service message including the unblocking code may be sent to the mobile communication device 100. The identity module 110 can then be unblocked using the unblocking code.

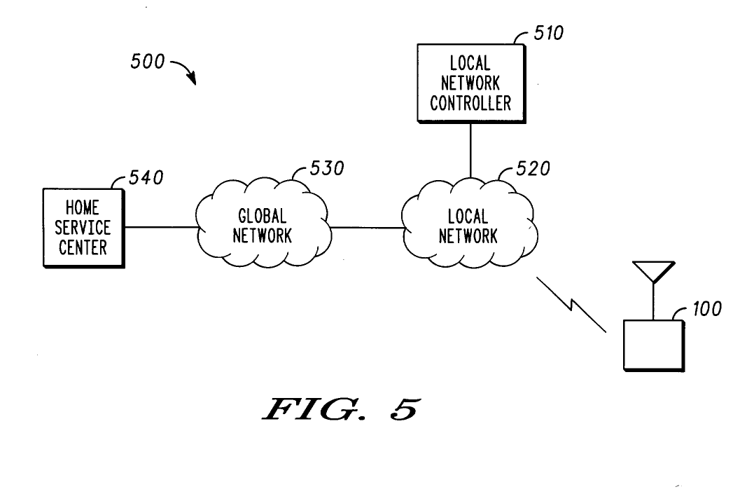

FIG. 5 is an exemplary block diagram of a system 500 for mobile communication according to one embodiment. The system 500 includes a local area network controller 510, a local network 520, a global network 530, and a home service center 540. The local network controller 510 controls the operations and access to the local network 520. The home service center 540 is the home service center for the mobile communication device 100. For example, the home service center 540 provides home access and also provides services for the mobile communication device 100. These services can include repair services, access services, communication services, or any other services for a subscriber to a mobile communication device network. The local network 520 may be any network providing for mobile communication device communications. The local network 520 is local to the mobile communication device 100. However, the local network is not necessarily local to the home service center 540.

The global network 530 may include a mobile communication network, a public land mobile network, or any other communication network. For example, the network 530 may include any type of network that is capable of sending and receiving communication signals. For example, the global network 530 may include a data network, such as the Internet, an Intranet, a local area network (LAN), a wide area network (WAN), a cable network, and other like communication systems. The global network 530 may also include a telecommunications network, such as a local telephone network, long distance telephone network, cellular telephone network, satellite communications network, cable television network and other like communications systems. Furthermore, the global network 530 may include more than one network and may include a plurality of different types of networks. Thus, the global network 530 may include a plurality of data networks, a plurality of telecommunications networks, a combination of data and telecommunications networks and other like communication systems. Additionally, the global network 530 may be any means of communication between a network, such as the local network 520, remote from the home service center 540 and the home service center 540.

In operation, a mobile communication device 100 may be roaming or not be registered on the local network 520. If the mobile communication device 100 requires service, the mobile communication device 100 may make an emergency service communication request to the local network controller 510. For example, the mobile communication device 100 may be in a blocked mode. Thus, the mobile communication device 100 cannot register on the local network 520. However, the mobile communication device 100 is allowed to make the emergency service request and send a subscriber identity to obtain assistance from the home service center 540 to unblock the mobile communication device 100.

According to a preferred embodiment, the local network controller 510 receives an emergency service call identifier from an unregistered mobile communication device 100 on the local network 520, the mobile communication device 100 being in a blocked mode. The local network controller 510 can also receive a subscriber identity 322 from the mobile communication device 100. The emergency service call identifier identifies an emergency service request to a home service center 540. The local network controller 510 routes the emergency service request and the subscriber identity 322 to the home service center 540. The home service center 540 can then send an unblock code upon verification of the subscriber's identity. The local network controller 510 then forwards the unblock code to the mobile communication device 100.

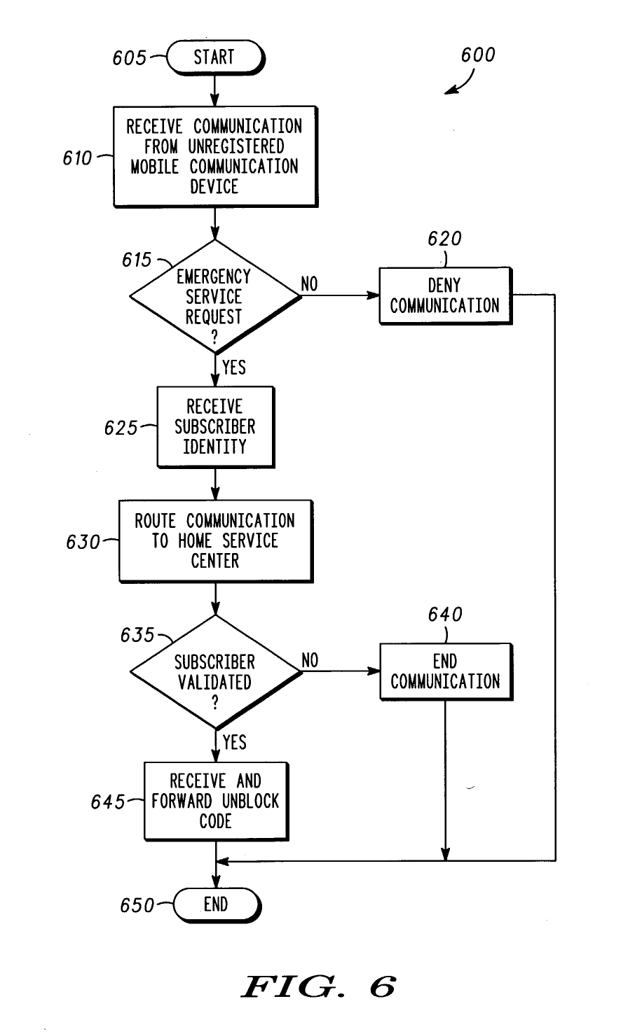

FIG. 6 is an exemplary flowchart 600 outlining the operation of the local network controller 510 according to a preferred embodiment. In step 605, the flowchart begins. In step 610, the local network controller 510 receives a communication from an unregistered mobile communication device 100. In step 615, the local network controller 510 determines if the communication is an emergency service request. If the communication is not an emergency service request (and it is not an emergency call, such as a 911 call) the local network controller 510 denies the communication in step 620. If the communication is an emergency service request, in step 625, the local network controller 510 receives the subscriber identity 322 from the mobile communication device 100. In step 630, the local network controller 510 routes the communication to the home service center 540. In step 635, the local network controller 510 determines if the subscriber is validated. For example, if the home service center 540 sends validation information within a predetermined time. If the subscriber is not validated, the local network controller 510 ends the communication in step 640. If the subscriber is validated, in step 645 the local network controller 510 receives and forwards an unblock code to the mobile communication device 100. In step 650, the flowchart ends.

According to another embodiment, the local network controller 510 receives an emergency service call identifier from an unregistered mobile communication device 100, the emergency service call identifier identifying an emergency service request to a home service center 540. The emergency service call identifier can include a subscriber identification 322. The emergency service call identifier can be received during a call type setup. Also, the emergency service call identifier can be received during a random access request from the mobile communication device on a random access channel. The emergency service call identifier can include a subscriber identification and a random access channel emergency service call type. The local network controller 510 can then route the emergency service request to the home service center 540. Upon validation, the local network controller 510 can receive and forward a short message service message to the mobile communication device 100 including an unblock code.

The method of this invention is preferably implemented on a programmed processor. However, mobile communication device controller 210, the identity module controller 310, and/or the local network controller 510 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention.

What is claimed is:

1. A method of establishing a network connection for an unregistered mobile communication device in a mobile communication network, comprising:
receiving an emergency service call identifier from the unregistered mobile communication device, the emergency service call identifier identifying an emergency service request to a home service center; and
routing the emergency service request to the home service center.

2. The method according to claim 1, wherein the emergency service call identifier includes a subscriber identification.

3. The method according to claim 1, further comprising sending a short message service message to the mobile communication device.

4. The method according to claim 3, wherein the short message service message includes an unblock code.

5. The method according to claim 1, wherein the receiving step further comprises receiving the emergency service call identifier during a call type setup.

6. The method according to claim 1, wherein the receiving step further comprises receiving the emergency service call identifier during a random access request from the mobile communication device on a random access channel.

7. The method according to claim 6, wherein the emergency service call identifier includes
a subscriber identification; and
a random access channel emergency service call type.

8. The method according to claim 1, wherein the mobile communication network is local to the mobile communication device and the mobile communication network is remote from the home mobile communication network of the mobile communication device.

9. The method according to claim 1, wherein the receiving step includes receiving an emergency service call identifier from the unregistered mobile communication device having a blocked subscriber identity module.

10. The method according to claim 9, further comprising:
receiving, from the home service center, an unblock code including data for unblocking the subscriber identity module; and
forwarding the unblock code to the unregistered mobile communication device.

11. A system for communication using a mobile communication device, comprising:
a local network; and
a controller coupled to the local network, the controller configured to receive an emergency service call identifier from an unregistered mobile communication device on the local network, the mobile communication device being in a blocked mode, the emergency service call identifier identifying an emergency service request to a home service center, and the controller is further configured to route the emergency service request to the home service center.

12. The system for communication using a mobile communication device according to claim 11, wherein the controller is further configured to receive a subscriber identity from the mobile communication device, forward the subscriber identity to the home service center, receive an unblock code from the home service center, and send the unblock code to the mobile communication device.

13. The system for communication using a mobile communication device according to claim 11, wherein the controller is further configured to send a short message service message including an unblock code to the unregistered mobile communication device.

14. The system for communication using a mobile communication device according to claim 11, wherein the controller is further configured to receive the emergency service call identifier during a call type setup.

15. The system for communication using a mobile communication device according to claim 11, wherein the controller is further configured to receive the emergency service call identifier during a random access request from the mobile communication device on a random access channel.

16. The system for communication using a mobile communication device according to claim 11, wherein the mobile communication network is local to the mobile communication device and the mobile communication network is remote from the home mobile communication network of the mobile communication device.

17. The system for communication using a mobile communication device according to claim 11, wherein the controller is further configured to receive an emergency service call identifier from the unregistered mobile communication device having a blocked subscriber identity module.

18. The system for communication using a mobile communication device according to claim 11, wherein the controller is further configured to receive, from the home service center, an unblock code including data for unblocking the subscriber identity module and forward the unblock code to the unregistered mobile communication device.

19. A method of establishing a network connection for a blocked mobile communication device in a mobile communication network, the method comprising:
receiving a service request from the blocked mobile communication device in an random access communication on a random access channel;
receiving international mobile subscriber identification information from the blocked mobile communication device; and
forwarding the international mobile subscriber identification information to a home service center.

20. The method according to claim 19, further comprising:
receiving unblocking information from the home service provider; and
forwarding the unblocking information to the blocked mobile communication device.
